(19) United States
(12) Patent Application Publication
(10) Pub. No.: US 2020/0226300 A1
(43) Pub. Date: Jul. 16, 2020

(54) IDENTIFIER OF A CLIENT DEVICE

(71) Applicant: HEWLETT-PACKARD DEVELOPMENT COMPANY, L.P., Spring, TX (US)

(72) Inventors: Tadeu Marchese, Porto Alegre (BR); José Dirceu Gründler Ramos, Porto Alegre (BR); Taciano Perez, Porto Alegre (BR)

(21) Appl. No.: 16/479,952

(22) PCT Filed: Oct. 3, 2017
(86) PCT No.: PCT/US2017/054896

§ 371 Date: Jul. 23, 2019

(51) Int. Cl. G06F 21/88; G06F 16/903; G06F 21/57; G06F 21/73

(52) U.S. Cl. CPC G06F 21/88; G06F 16/90335; G06F 2221/034; G06F 21/73; G06F 21/575

(57) ABSTRACT

A system may include a non-transitory computer readable medium and a processor. Instructions stored on the non-transitory computer readable medium may include instructions to transmit an identifier of a client device to a database. Instructions may further be executable to receive a code from the database indicating that the client device is allowed to boot. Further instructions may be executable by the processor to run an operating system of the client device in response to receiving the code from the database.

### BACKGROUND

Client devices, such as computing devices, may include identifiers usable to distinguish one client device from another. These identifiers may be storable and thus may be used to identify a status of the client device at a particular time. Since a client device identifier is unique to its client device, the status of the client device may be determined for each individual client device using the client device identifier.

### BRIEF DESCRIPTION OF THE DRAWINGS

FIG. 1 is an example system associated with an identifier of a client device consistent with the present disclosure.

FIG. 2 is another example system associated with an identifier of a client device consistent with the present disclosure.

FIG. 3 is an example method associated with an identifier of a client device consistent with the present disclosure.

FIG. 4 is another example method associated with an identifier of a client device consistent with the present disclosure.

### DETAILED DESCRIPTION

Computing devices may be susceptible to theft, both during storage and transport from a manufacturer to a sales location and from home(s) or office(s) of an end user. When a computing device is stolen or otherwise misplaced, security concerns may arise. For example, an unauthorized user may gain access to the device, thus enabling the user to acquire sensitive or personal information about the device's owner. Moreover, a device that is stolen during transport from a manufacturer may represent a financial loss to both the manufacturer and the intended seller of the device.

Anti-theft devices may aid in reducing instances of computing device theft. One type of anti-theft device is a physical lock. A lock may be coupled to the computing device at, for example, a port of the device. The lock may include a cable to couple the computing device to a sturdy object, such as a table, a desk, or a display case. The lock may be releasable by, for example, inputting a numerical combination. In some examples, a computing device may be physically locked while not in use and be unlocked while being used. However, physical locks may lack the capability to prevent an unauthorized user from accessing the operating system of the computing device. Additionally, physical locks may be forcibly removed from the computing device and/or from the object to which the computing device is coupled. While forcible removal of the lock may cause damage to the computing device and/or the object, the internal hardware of the computing device may remain unharmed and thus remain useable.

Other anti-theft devices may be integrated with the computing device itself. For example, one type of integrated anti-theft device may be an application installed on the Basic Input/Output System (BIOS) of a computing device. As used herein, BIOS refers to firmware of a computing device used both to perform hardware initialization during the booting process and to provide runtime services for programs and operating systems of the computing device. In some examples, the application installed on the BIOS may be used to verify the existence of instructions corresponding to the application, which may be installed within memory of the computing device. When activated, the instructions may be executable to search for the location of the device, as well as to determine whether the device has been reported stolen. However, the instructions may lack the ability to lock the computing device at the BIOS level. Thus, even if the computing device is reported stolen, the computing device may still be usable. Although the instructions may permit installation of additional third-party features (e.g., a keystroke logger or a forensic package) to aid in tracking the computing device, the device itself may remain operational.

Another type of integrated anti-theft device may use additional hardware within the computing device. For example, a computing device may include a specialized radio-frequency identification (RFID) chip. As used herein, an RFID chip refers to a chip or tag that may be attached to an object and uses electromagnetic fields to identify and/or track the object to which it is attached. In a computing device, an anti-theft RFID chip may be included within the computing device itself. If the computing device is reported stolen, the RFID chip may be tracked to determine the location of the computing device. However, the RFID chip may lack the ability to lock the computing device; thus, while the computing device may be tracked, the computing device may remain usable,

An identifier of a client device according to the present disclosure, by contrast, may leverage an existing Unified Extensible Firmware Interface (UEFI) for anti-theft applications. As used herein, UEFI refers to an interface connecting an operating system of a computing device and the platform firmware of the computing device. UEFI may be operable on a computing device regardless of the particular operating system installed on the device, and may be operable when no operating system is installed. An identifier of a client device according to the present disclosure may include a module installed as part of the UEFI that, when the computing device begins to run the UEFI, checks the identifier of the client device against a database of identifiers of client devices to determine whether the client device is permitted to continue its booting process by, for example, beginning to run its operating system. As used herein, a module refers to a self-contained unit within a larger unit, such as a UEFI, that performs a particular defined task. If the client device is permitted to run, the UEFI may continue the booting process; however, if the client device is not permitted to run, the UEFI may terminate the booting process and lock the computing device such that is not usable.

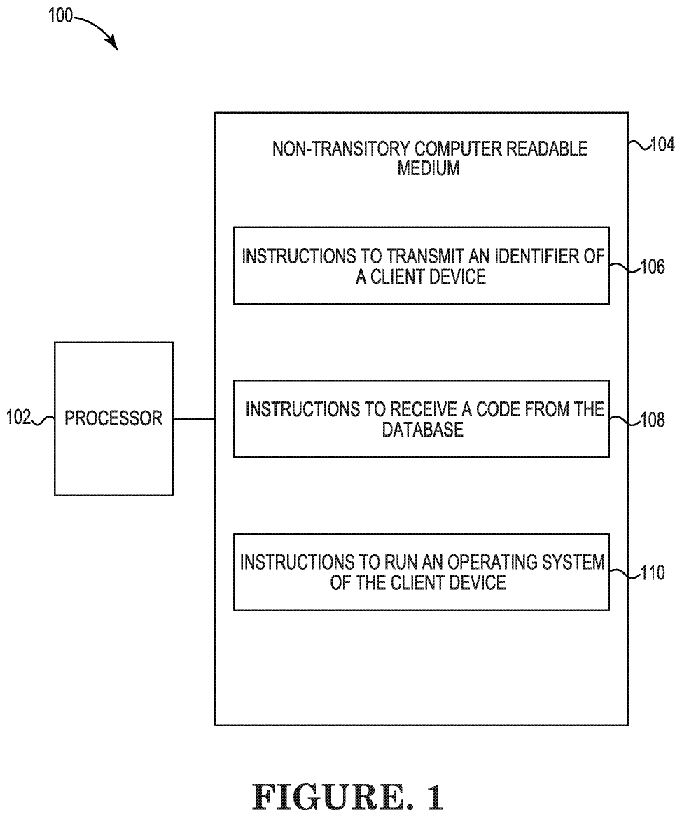

FIG. 1 is an example system 100 associated with an identifier of a client device. System 100 may include processor 102. System 100 may further include a non-transitory computer readable medium 104 on which may be stored instructions, such as instructions 106. 108, and 110. Although the following descriptions refer to a single processor and a single non-transitory computer readable medium, the descriptions may also apply to a system with multiple processors and multiple non-transitory computer readable media. In such examples, the instructions may be distributed (e.g., stored) across multiple non-transitory computer-readable media and the instructions may be distributed (e.g., executed by) across multiple processors.

Processor 102 may be a central processing unit (CPU), a semiconductor based microprocessor, and/or other hardware devices suitable for retrieval and execution of instructions stored in non-transitory computer readable medium 104. Processor 102 may fetch, decode, and execute instructions 106, 108, 110, or a combination thereof. As an alternative or in addition to retrieving and executing instructions, processor 102 may include at least one electronic circuit that includes electronic components for performing the functionality of instructions 106, 108, 110,or a combination thereof.

Non-transitory computer readable medium 104 may be electronic, magnetic, optical, or other physical storage device that stores executable instructions. Thus non-transitory computer readable medium 104 may be, for example, Random Access Memory (RAM), an Electrically-Erasable Programmable Read-Only Memory (EEPROM), a storage drive, an optical disc, and the like. Non-transitory computer readable medium 104 may be disposed within system 110, as shown in FIG. 1. In this example, the executable instructions may be “installed” on the system. Additionally and/or alternatively, non-transitory computer readable medium 104 may be a portable, external or remote storage medium, for example, that allows system 100 to download the instructions from the portable/external/remote storage medium. In this situation, the executable instructions may be part of an “installation package”. As described herein, non-transitory computer readable medium 104 may be encoded with executable instructions associated with an identifier of a client device.

Instructions 106 may include instructions executable by processor 102 to transmit an identifier of a client device. As used herein, an identifier of a client device refers to a numeric or alphanumeric combination that may correspond to a particular client device, and may therefore be used to distinguish one client device from another client device. An identifier of a client device may, for example, include a part number, a serial number, or any other combination of numbers and/or letters that uniquely identify the particular client device. The client device identifier may be transmitted to a database. As used herein, a database refers to a collection of information stored for easy access, management, and/or updating. In some examples, the client device identifier may be transmitted by instructions 106 to a database of client device identifiers. That is, the database may include a plurality of identifiers of a plurality of client devices including the particular identifier of a client device.

In some examples, instructions 106 may include instructions executable by processor 102 to transmit an encrypted identifier of a client device. As used herein, an encrypted identifier of a client device refers to an identifier that is encoded so as to be unreadable by anyone not in possession of a key. The identifier of the client device may be encrypted to provide additional security during transmission to the database. Upon transmission of the encrypted identifier of the client device to the database by instructions 106, decryption may occur at the database. That is, the database may decrypt the encrypted identifier of the client device

Instructions 106 may further include instructions executable by processor 102 to connect the client device to the database. In some examples, the client device may be connected to the database through a network connection. The network connection may correspond to a UEFI connectivity interface, such as Network Stack or a particular network interface. Connection of the client device to the database may permit transmission of the identifier of the client device to the database by instructions 106.

Instructions 106 may include further instructions executable by processor 102 to determine the identifier of the client device. As described previously, the identifier of a client device may comprise a series of numbers and/or letters used to distinguish one client device from another. The identifier of a client device may be stored within the client device, for example, in a module of the UEFI. In some examples, the instructions executable to determine the identifier of a client device may further include instructions to encrypt the client device identifier using a secret key.

Instructions 108, when executed by processor 102, may include instructions to receive a code from the database. As used herein, a code refers to an alphanumeric sequence used to transmit information. For instance, a code may inform a pattern of behavior; that is, receipt of a particular code may cause performance of a corresponding action, while receipt of a different code may cause performance of a different action. In some examples, the code may indicate that the client device is allowed to boot. That is, the code received from the database by instructions 108 may specify that the client device is permitted to continue its startup operations,

The code received by instructions 108 may be received in response to a comparison of the client device identifier transmitted by instructions 106 to the database of client device identifiers. Within the database of identifiers of client devices, individual identifiers of client devices may be marked. In some examples, an individual identifier of a client device may be marked as either “allowed” or “non-allowed”. An “allowed” marking may indicate that the client device is not reported missing or stolen, and is thus to be permitted to boot. A “non-allowed” marking, by contrast, may indicate that the client device has been reported stolen and thus is to be locked and not permitted to boot. In some examples, an “allowed” marking may be a default marking, and a “non-allowed” marking may be made in response to contact by the owner of the client device reporting the client device missing or stolen. In other examples, such as during transport from a manufacturer, the “non-allowed” marking may be the initial default marking, and the “allowed” marking may be made in response to a purchaser taking possession of the client device. A code indicating the client device is permitted to boot, such as the code received by instructions 108, may thus correspond to an indication that the identifier of a client device transmitted by instructions 106 corresponds to an “allowed” identifier of a client device in the database.

Instructions 110 may include instructions executable by processor 102 to run an operating system of the client device. In some examples, the operating system of the client device may run in response to receipt of the code from the database by instructions 108. In such examples, instructions 110 may be executable to run an operating system of the client device in response to receiving a code from the database by instructions 108 that the client device identifier is marked “allowed” in the database of client device identifiers.

System 100 may further include instructions executable by processor 102 to determine a period of time elapsed since receipt of the code from the database, such as by instructions 108. In some examples, the period of time may be measured from the time at which the code was received by instructions 108. The period of time may include a time at which the client device was turned off after use. System 100 may include further instructions executable by processor 102 to refrain from transmitting the identifier of the client device to the database. In some examples, the identifier of the client device may not be transmitted to the database when the determined elapsed period of time being below a threshold period of time. Said differently, the identifier of the client device may not be transmitted to the database if the identifier of the client device has been transmitted to and checked against the database within a particular period of time. For example, if a client device has an identifier of the client device transmitted and then is restarted two hours later, the elapsed period of time may be two hours, which may be below a threshold period of time of 24 hours. Examples are not so limited, however, and any threshold period of time may be used.

System 100 may include instructions executable by processor 102 to receive a different code from the database. In some examples, the different code may indicate that the client device is not allowed to boot. For example, the different code may be received in response to a determination that the identifier of the client device transmitted by, for example, instructions 106, is marked as “not allowed” in the database of identifiers of client devices. In response to receiving the different code from the database, system 100 may include instructions executable by processor 102 to refrain from running the operating system of the client device. That is, system 100 may include instructions executable by processor 102 to not engage in the booting process for the client device in response to receiving the different code from the database. In some examples, system 100 may further include instructions executable by processor 102 to display a message. The message may indicate that the client device is not permitted to boot and may be displayed in response to receipt of the different code from the database. In some examples, the message may be displayed on a screen of the client device, such that a user of the client device may read and be aware that the client device is not allowed to boot.

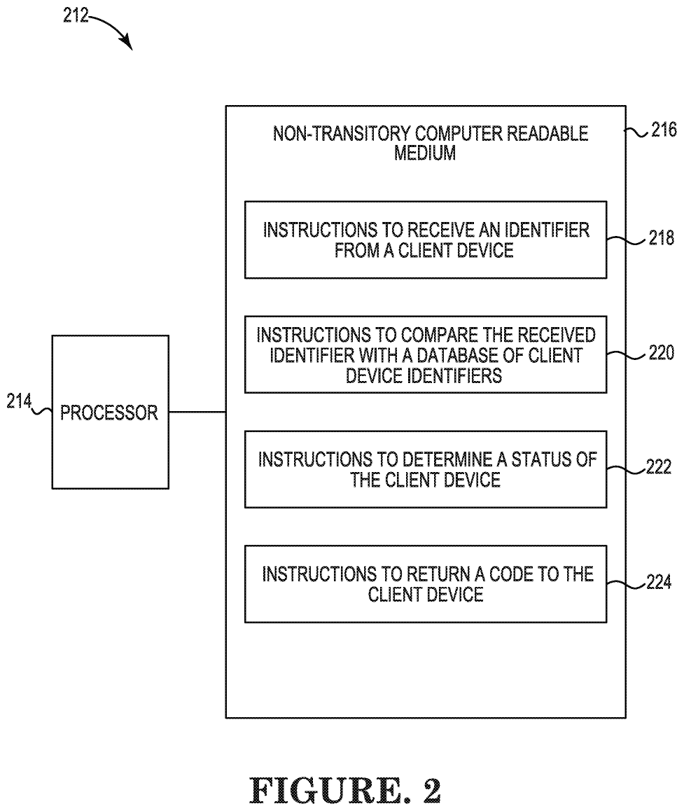

FIG. 2 is another example system 212 associated with an identifier of a client device consistent with the present disclosure. System 212 may include a processor 214. Processor 214 may be akin to processor 102, described with respect to FIG. 1. System 212 may further include a non-transitory computer readable medium 216. Non-transitory computer readable medium 216 may be akin to non-transitory computer readable medium 104, described with respect to FIG. 1. As shown in FIG. 2, non-transitory computer readable medium 216 may include instructions associated with an identifier of a client device consistent with the present disclosure.

Instructions 218 may include instructions executable by processor 214 to receive an identifier of a client device. As described with respect to FIG. 1, an identifier of a client device may be a numeric or alphanumeric series that distinguishes one client device from another client device. The identifier of the client device may be received at, for example, a database of identifiers of client devices. In some examples, instructions 218 may include instructions executable by processor 214 to receive an encrypted identifier of a client device from the client device. The encrypted identifier of the client device may be received by instructions 218 and may be decrypted upon receipt. In some examples, the encrypted identifier of the client device may be decrypted using a stored key corresponding to the key used to initially encrypt the identifier of the client device.

Instructions 220 may include instructions executable by processor 214 to compare the received identifier of a client device with a database of identifiers of client devices. In some examples, the database of identifiers of client devices may comprise a plurality of identifiers for a set of client devices. The set of client devices may include the particular client device. Comparing the received identifier of a client device with a database of identifiers of client devices by instructions 220 may further comprise comparing the received identifier of a client device with a subset of the database of identifier of client devices. In some examples, the subset of the database of identifiers of client devices may correspond to marked identifier of client devices. That is, the subset of the database of identifiers of client devices may be a subset of identifiers that are tagged. As described with respect to FIG. 1, the identifier of client devices may be marked as, for example, “allowed” or “not allowed”, although examples are not so limited.

Instructions 222 may include instructions executable by processor 214 to determine a status of the client device. In some examples, the status of the client device determined by instructions 222 may be based on the comparison of the received identifier of a client device with the database of identifiers of client devices. For example, a status of the client device may be determined by instructions 222 as “not stolen” when the received identifier of a client device corresponds to an identifier of a client device in the database that is marked as “allowed”. In some examples, determining a status of the client device by instructions 222 may include instructions executable by processor 214 to determine that the client device is marked as stolen. In such examples, the determination that the client device is marked as stolen may be made in response to the determination that the identifier of a client device compared by instructions 220 is marked as “not allowed” in the database of identifier of a client device,

Instructions 224 may include instructions executable by processor 214 to return a code to the client device. The code returned to the client device may be based on the determined status of the client device. That is, a type of code returned to the client device by instructions 224 may be based on the status of the client device determined by instructions 222. In some examples, instructions 224 may include instructions executable by processor 214 to return a code to the client device indicating that an operating system of the client device is permitted to run. In such examples, the code indicating the operating system of the client device is permitted to run may be based on a determination that the status of the client device is “not stolen” or “allowed”. In other examples, instructions 224 may include instructions executable by processor 214 to return a code to the client device is not permitted to run. In such examples, the code indicating that the operating system is not permitted to run may be based on a determination that the status of the client device is “stolen” or “not allowed”.

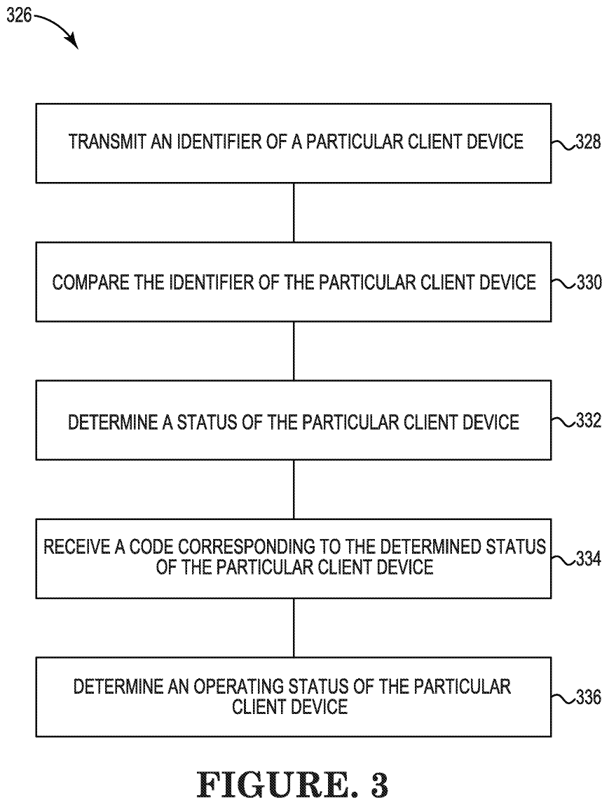

FIG. 3 is an example method 326 associated with an identifier of a client device consistent with the present disclosure. At 328, method 326 may include transmitting a particular identifier of a client device. The particular identifier of a client device may be transmitted to a database of identifiers of client devices. In some examples, the particular identifier of a client device may be transmitted upon connection by the client device to the database of client device identifiers. As described with respect to FIG. 1, the client device may connect to the database through a UEFI service of the client device.

In some examples, transmitting a particular identifier of a client device at 328 may include encrypting the particular identifier of a client device prior to transmission. The particular identifier of a client device may be encrypted at the UEFI of the client device and, once encrypted, may be transmitted to the database of identifiers of client devices. In some examples, the database of identifiers of client devices may possess a key to decrypt an encrypted identifier of a client device, such that upon receipt of an encrypted identifier of a client device, the database of identifiers of client devices may decrypt the particular identifier. In other examples, the database of identifiers of client devices may receive a subsequent transmission, wherein the subsequent transmission includes a key to decrypt the particular identifier of a client device.

At 330, method 326 may include comparing the particular identifier of a client device with the identifiers of client devices in the database. As described with respect to FIG. 2, comparing the particular identifier of a client device may comprise comparing the particular identifier of a client device with a subset of the identifiers in the database. In some examples, the subset of identifiers in the database may correspond to identifiers of client devices that are marked.

At 332, method 326 may include determining a status of the particular client device. In some examples, determining a status of the particular client device at 332 may be based on the comparison of the particular identifier of a client device with the database of identifiers of client devices at 330. That is, the status of the particular client device may be determined at 332 based on comparing the particular identifier of a client device with the database of identifiers of client devices. In some examples, the status of the client device may be determined to be “not stolen”, “not locked”, or “allowed”, when the particular identifier of the client device corresponds to an identifier in the database that is not marked. In other examples, the status of the client device may be determined to be “stolen”, “locked”, or “not allowed”, when the particular identifier of the client device corresponds to a marked identifier in the database.

In some examples, determining a status of the particular client device at 332 may include determining the status of the particular client device when the particular identifier of the client device is not in the database of identifiers. Said differently, determining a status of the particular client device at 332 may include determining that the particular identifier of the client device is not among the identifiers within the database. In such examples, a comparison of the particular identifier of the client device to an identifier of a client device in a database, such as at 330, may not occur, as the database may not include a corresponding identifier for comparison. When a comparison is unable to be performed, determining a status of the particular client device at 332 may include determining that the status of the client device is to default to “stolen”, “locked”, or “not allowed”. Said differently, the status of the client device may be determined to be “stolen”, “locked”, or “not allowed” when a comparison of the particular identifier of the client device to an identifier within the database is unable to be performed.

At 334, method 326 may include receiving a code. In some examples, the code may correspond to the determined status of the particular client device, determined at 332. For instance, a client device determined to be “allowed” may have corresponding code returned. That is, a code received at 334 may correspond to the status of the particular client device.

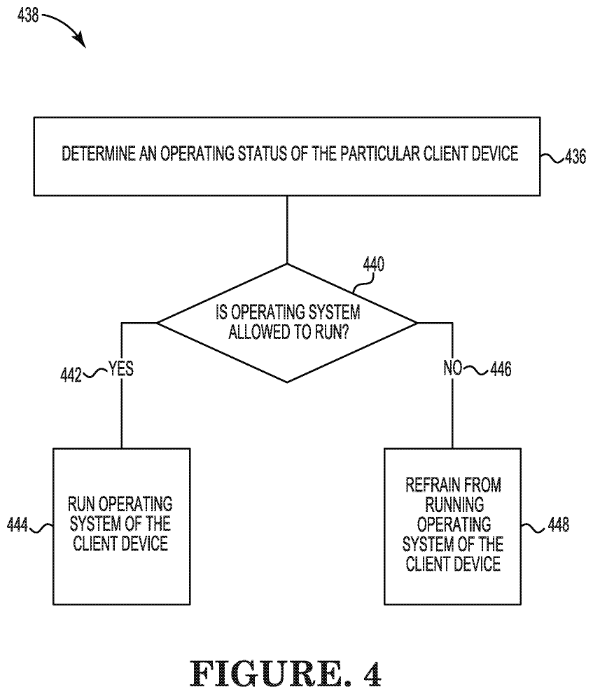

At 336, method 326 may include determining an operating status of the particular client device. In some examples, determination of the operating status of the particular client device at 336 may be based on the code received at 334. That is, the operating status of the particular client device may be determined using the received code. Determination of the operating status is discussed further herein with respect to FIG. 4.

FIG. 4 is another example method 438 associated with an identifier of a client device consistent with the present disclosure. At 436, method 438 may include determining an operating status of the particular client device. The particular client device may be the same particular client device discussed with respect to FIG. 3. Determining an operating status of the particular client device at 436 may be akin to determining an operating status of the particular client device at 336, described with respect to FIG. 3.

At 440, method 438 may include determining whether an operating system of the particular client device is allowed to run. In some examples, the determination as to whether the operating system of the particular client device is permitted to run at 440 may be based on the determination of the operating status of the particular client device made at 438. That is, whether an operating system of the particular client device is allowed to run may be based on the determined operating status of the particular client device.

If an operating system of the particular client device is permitted to run (“yes” 442), method 438 may include running an operating system of the client device at 444. In some examples, “yes” 442 may correspond to a determination made at 440 that the received code indicates that the client device is allowed to run its operating system. Thus, at 444, method 438 may include running the operating system. In some examples, running the operating system at 444 may include completing a booting process of the client device, such that the client device may be usable.

If, however, an operating system of the particular client device is not permitted to run (“no” 446), method 438 may include refraining from running an operating system of the client device at 448. In some examples, “no” 446 may correspond to a determination made at 440 that the received code indicates that the client device is not permitted to run its operating system. That is, a “no” determination 446 may correspond to a received code indicating that the client device identifier is marked and thus that the operating system of the client device is not to run. In some examples, refraining from running the operating system at 448 may include terminating a booting process, such as a booting process run by a UEFI of the client device. Moreover, refraining from running the operating system at 448 may include displaying a message on the client device indicating that the operating system is not to run.

Method 438 may further include receiving a password input. As used herein, a password refers to an alphanumeric sequence used to provide access to a device. In some examples, the password input may be received at a displayed screen indicating that the operating system of the client device is not to run. That is, a password input prompt may be displayed when the operating system of the client device is to refrain from running at 448.

Upon receipt of a password input, method 438 may include verifying the inputted password. Verifying the inputted password may include comparing the inputted password with a known password. The known password may be stored within the client device and may be accessed for comparison with the inputted password.

If the inputted password is verified, method 438 may further include running an operating system of the client device. The operating system may be run upon successful password verification even though the operating system was refrained from running at 448. That is, successful password verification may permit the operating system to run even if the operating system was previously determined to not be permitted to run (e.g., “no” 446). However, if the inputted password is unable to verified, the operating system of the client device may continue to refrain from running. Said differently, the operating system of the client device may not run if the inputted password does not match the known password stored in the computing device.

In the foregoing detail description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that structural changes may be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. Further, as used herein, “a number of” an element and/or feature can refer to any number of such elements and/or features.

What is claimed:

1. A non-transitory computer readable medium containing instructions executable by a processor to:
transmit an identifier of a client device to a database;
receive a code from the database indicating that the client device is allowed to boot; and
run an operating system of the client device in response to receiving the code from the database.

2. The non-transitory computer readable medium of claim 1, wherein the instructions executable to transmit an identifier of a client device further comprise instructions executable to:
connect the client device to the database; and
determine the identifier of the client device.

3. The non-transitory computer readable medium of claim 1, further comprising instructions executable by the processor to:
determine a period of time elapsed since receipt of the code from the database; and
refrain from transmitting the identifier of the client device to the database in response to the elapsed period of time being below a threshold period of time.

4. The non-transitory computer readable medium of claim 1, further comprising instructions executable by the processor to:
receive a different code from the database indicating that the client device is not allowed to boot; and
refrain from running the operating system of the client device in response to receiving the different code from the database.

5. The non-transitory computer readable medium of claim 4, further comprising instructions executable by the processor to display a message indicating that the client device is not allowed to boot in response to receipt of the different code from the data base.

6. A non-transitory computer readable medium containing instructions executable by a processor to:
receive an identifier from a client device;
compare the received identifier with a database of client device identifiers;
determine a status of the client device based on the comparison of the received identifier with the database of client identifiers; and
return a code to the client device, wherein the code is based on the determined status of the client device.

7. The non-transitory computer readable medium of claim 6, wherein the database of client devices identifiers comprises a plurality of identifiers of a set of client devices including the particular client device.

8. The non-transitory computer readable medium of claim 6, wherein the instructions executable to compare the received identifier with a database of client device identifiers include instructions executable by the processor to:
compare the received identifier with a subset of the database of client device identifiers, wherein the subset of client device identifiers corresponds to marked client device identifiers.

9. The non-transitory computer readable medium of claim 6, wherein the instructions executable to determine a status of the client device include instructions executable by the processor to determine that the client device is marked as stolen.

10. The non-transitory computer readable medium of claim 6, wherein the instructions executable to return a code to the client device include instructions executable by the processor to return a code to the client device indicating that an operating system of the client device is permitted to run.

11. The non-transitory computer readable medium of claim 6, wherein the instructions executable to return a code to the client device include instructions executable by the processor to return a code to the client device indicating that an operating system of the client device is not permitted to run.

12. A method, comprising:
transmitting an identifier of a particular client device to a database of client device identifiers;
comparing the identifier of the particular client device to the client device identifiers in the database;
determining a status of the particular client device based on the comparison of the identifier of the particular client device to the database of client identifiers;
receiving a code corresponding to the determined status of the particular client device; and
determining, based on the received code, an operating status of the particular client device.

13. The method of claim 12, wherein determining, based on the received code, an operating status of the particular client device further comprises:
determining that the received code indicates that the client device is allowed to run its operating system; and
running the operating system of the client device.

14. The method of claim 12, wherein determining, based on the received code, an operating status of the particular client device further comprises:
determining that the received code indicates that the client device is not allowed to run its operating system;
refraining from running the operating system of the client device; and
displaying a screen indicating that the client device is not allowed to run its operating system.

15. The method of claim 14, further comprising:
receiving a password input at the displayed screen;
verifying the inputted password; and
running the operating system of the client device in response to verification of the inputted password.
